(19) United States
(12) Patent Application Publication
(10) Pub. No.: US 2021/0334465 A1
(43) Pub. Date: Oct. 28, 2021

(54) MULTI-RELATION FUSION METHOD AND INTELLIGENT SYSTEM FOR LATENT-ASSOCIATION LBD

(71) Applicant: Guangdong Polytechnic Norma! University, Guangdong (CN)

(72) Inventor: Xiaoyong LIU, Guangdong (CN)

(21) Appl. No.: 16/627,796

(22) PCT Filed: May 31, 2019
(86) PCT No.: PCT/CN2019/089509

§ 371 Date: Dec. 31, 2019

(30) Foreign Application Priority Data
Jun. 30, 2018 (CN) 201810702397.7

(51) Int. Cl. G06F 40/30; G06F 40/279; G06N 5/02

(52) U.S. Cl. CPC G06F 40/30; G06N 5/02; G06F 40/279

(57) ABSTRACT

A multi-relation fusion method for latent-association literature-based discovery, containing the following steps: identifying a first term set TC-Terms associated with topic compactness of a starting concept A and a first term set MSR-Terms associated with semantics of the starting concept A, forming a matrix of a linking concept set B_{TC} and a matrix of a linking concept set B_{MSR}; obtaining a linking concept B through fusion of a co-occurrence relation and a semantic relation; identifying a second term set TC-Terms associated with topic compactness of the linking concept B and a second term set MSR-Terms associated with semantics of the linking concept B, forming a matrix of a target concept set C_{TC} and a matrix of a target concept set C_{MSR}; obtaining a target concept C like the linking concept B; and performing co-occurrence detection on the starting concept A and the target concept C.

### BACKGROUND OF THE INVENTION

The present disclosure pertains to the technical field of intelligent system and knowledge engineering researches, and specifically pertains to a multi-relation fusion method and intelligent system for latent-association literature-based discovery (LBD).

Literature-based discovery (LBD) technology pioneered by Don R. Swanson has been developed for many years and has been researched by numerous scholars. Through the LBD technology, the scholars are not limited to a narrow research field known by themselves, and can avoid a scientific island situation to effectively support interdisciplinary creation. However, throughout the current domestic and international associated researches, the LBD technology and an associated intelligent system have the following disadvantages:

1, A term selection method needs to be improved.

in the current mainstream term-co-occurrence-based LBD method researches, selection of a term generally is not associated with topic compactness of the term, for example, selection of a linking concept generally ignores compactness of a starting concept with a topic of an initial literature. The linking concept B generally is extracted (selected) from an initial literature set a obtained by retrieving the starting concept A, and then is sequenced and filtered by utilizing A-B co-occurrence. However, when the linking concept B is selected, there are two cases:

(1), if the starting concept A is strongly associated with the topic of the initial literature set a, the linking concept B extracted (selected) from the initial literature set a may be strongly associated with the starting concept A; and

(2), if the starting concept A is weakly associated with the topic of the initial literature set a, the linking concept B extracted (selected) from the initial literature set a may be weakly associated with the starting concept A and may not be suitable for being utilized as a linking concept;

However, it is not researched and reported that selection of the linking concept is influenced by different degree of topic compactness of the starting term A and the initial literature set a. Ignoring topic compactness characterizing a topic association degree of the term and the literature is a main factor to cause a large amount of latent association to be finally generated in the current LBD method.

2, Identification of a latent-association term pair ignores a semantic relation objectively existed between the term pair.

The current LBD research finds association of terms mainly based on term co-occurrence, and is lack of considering the semantic relation really existed between the term pair. Although Hu, Hristovski and the like respectively put forwards semantics-based LBD technologies, Kostoff indicates that algorithms of these semantics-based LBD technologies still essentially are simple term-co-occurrence-based technologies in the mainstream LBD researches. A-B co-occurrence do not certainly represent that the A and the B have a semantic relation. Therefore, it is not reliable of latent-association knowledge finally obtained by the LBD technology simply based on the term co-occurrence.

### BRIEF SUMMARY OF THE INVENTION

An objective of the present disclosure is to provide a multi-relation fusion method and intelligent system for latent-association LBD to solve defects in the prior art.

According to a disclosed embodiment, in a first aspect, the present disclosure discloses a multi-relation fusion method for latent-association LBD, which comprises the following steps:

providing a starting concept A, and finding out an initial literature set a in a retrieving manner;

identifying a first term set TC-Terms associated with topic compactness of the starting concept A, and forming a matrix of a linking concept set B_{TC};

identifying a first term set MSR-Terms associated with semantics of the starting concept A, and forming a matrix of a linking concept set B_{MSR};

obtaining a linking concept B through fusion of a common relation and a semantic relation;

retrieving the linking concept B to find out a linking literature set b;

identifying a second term set TC-Terms associated with topic compactness of the linking concept B, and forming a matrix of a target concept set C_{TC};

identifying a second term set MSR-Terms associated with semantics of the linking concept B, and forming a matrix of a target concept set C_{MSR};

obtaining a target concept C through the fusion of the common relation and the semantic relation; and

performing co-occurrence detection on the starting concept A and the target concept C; if the starting concept A and the target concept C do not co-occur in the same literature, storing them in a latent-association knowledge base; and if the starting concept A and the target concept C co-occur in the same literature, not storing that the starting concept A and the target concept C are associated.

Further, the fusion of a common relation and a semantic relation is performed based on a Stouffer's Z-score fusion algorithm.

According to a disclosed embodiment, in a second aspect, the present disclosure discloses a multi-relation fusion intelligent system for latent-association LBD, which comprises:

a starting concept retrieving unit, used for providing a starting concept A, and finding out an initial literature set a in a retrieving manner;

an A topic compactness associated term identifying unit, used for identifying a first term set TC-Terms associated with topic compactness of the starting concept A, and forming a matrix of a linking concept set B_{TC};

an A semantically associated term identifying unit, used for identifying a first term set MSR-Terms associated with semantics of the starting concept A, and forming a matrix of a linking concept set B_{MSR};

a linking concept relation fusion unit, used for obtaining a linking concept B through fusion of a common relation and a semantic relation;

a linking concept retrieving unit, used for retrieving the linking concept B to find out a linking literature set b;

a B topic compactness associated term identifying unit, used for identifying a second term set TC-Terms associated with topic compactness of the linking concept B, and forming a matrix of a target concept set C_{TC};

a B semantically associated term identifying unit, used for identifying a second term set MSR-Terms associated with semantics of the linking concept B, and forming a matrix of a target concept set C_{MSR};

a target concept retrieving unit, used for obtaining a target concept C through the fusion of the common relation and the semantic relation; and

a co-occurrence detecting unit, used for performing co-occurrence detection on the starting concept A and the target concept C; if the starting concept A and the target concept C do not co-occur in the same literature, storing them in a latent-association knowledge base; and if the starting concept A and the target concept C co-occur in the same literature, not storing that the starting concept A and the target concept C are associated.

Further, the fusion of a common relation and a semantic relation is performed based on the Stouffer's Z-score fusion algorithm in the linking concept retrieving unit and the target concept retrieving unit.

Compared with the prior art, the present disclosure has the following advantages and effects:

the present disclosure identifies actually existed and semantically associated latent knowledge association between a term pair based on the latent knowledge association, which is identified by a co-occurrence method based on topic compactness of the terms, and based on researches on the semantic relation included by the term pair; the relation fusion is performed based on the Stouffer's Z-score fusion algorithm; and compared with the current domestic and international mainstream LBD technology, the present disclosure can find out more reliable and valuable latent knowledge association.

### BRIEF DESCRIPTION OF THE DRAWINGS

FIG. 1 is a flowchart of a multi-relation fusion method for latent-association LBD disclosed by the present disclosure.

FIG. 2 is a schematic structural diagram of a multi-relation fusion intelligent system for latent-association LBD.

### DETAILED DESCRIPTION OF THE INVENTION

To make the objectives, technical solutions, and advantages of the embodiments of the present disclosure dearer, the following clearly and completely describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

### Embodiment 1

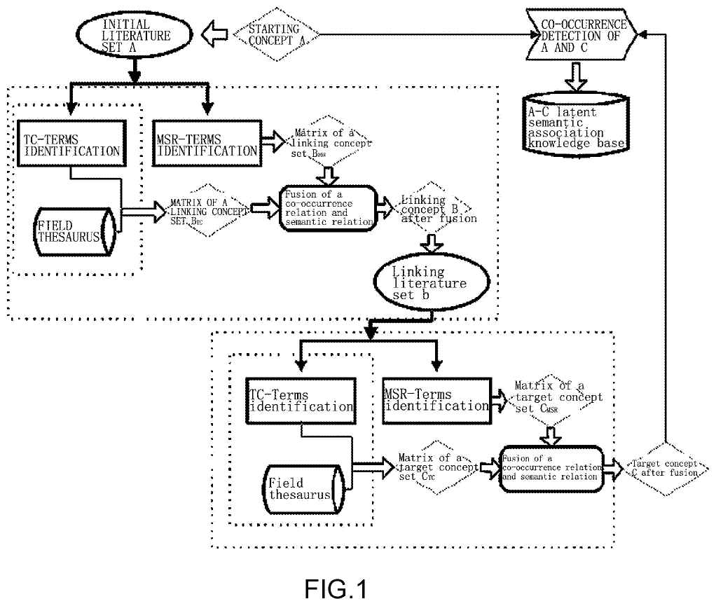

As shown in FIG. 1, the embodiment discloses a multi-relation fusion method for latent-association LBD, which comprises the following steps:

providing a starting concept A, and finding out an initial literature set a in a retrieving manner;

identifying a first term set TC-Terms associated with topic compactness of the starting concept A, and forming a matrix of a linking concept set B_{TC};

identifying a first term set MSR-Terms associated with semantics of the starting concept A, and forming a matrix of a linking concept set B_{MSR};

obtaining a linking concept B through fusion of a common relation and a semantic relation;

retrieving the linking concept B to find out a linking literature set b;

identifying a second term set TC-Terms associated with topic compactness of the linking concept B, and forming a matrix of a target concept set C_{TC};

identifying a second term set MSR-Terms associated with semantics of the linking concept B, and forming a matrix of a target concept set C_{MSR};

obtaining a target concept C through the fusion of the common relation and the semantic relation; and

performing co-occurrence detection on the starting concept A and the target concept C; if the starting concept A and the target concept C do not co-occur in the same literature, storing them in a latent-association knowledge base; and if the starting concept A and the target concept C co-occur in the same literature, not storing that the starting concept A and the target concept C are associated.

In the embodiment, the fusion of a common relation and a semantic relation is performed based on a Stouffer's Z-score fusion algorithm.

### Embodiment 2

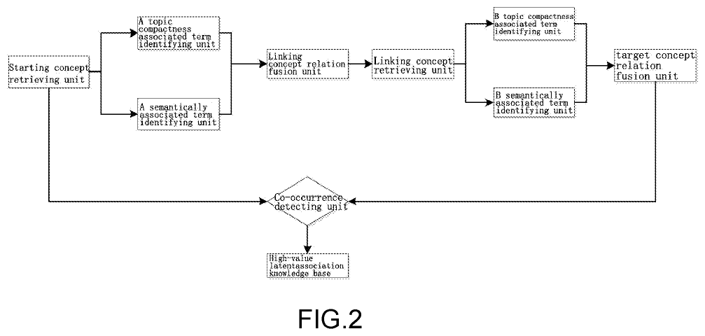

As shown in FIG. 2, the embodiment discloses a multi-relation fusion intelligent system for latent-association LBD, which comprises:

a starting concept retrieving unit, used for providing a starting concept A, and finding out an initial literature set a in a retrieving manner;

an A topic compactness associated term identifying unit, used for identifying a first term set TC-Terms associated with topic compactness of the starting concept A, and forming a matrix of a linking concept set B_{TC};

an A semantically associated term identifying unit, used for identifying a first term set MSR-Terms associated with semantics of the starting concept A, and forming a matrix of a linking concept set B_{MSR};

a linking concept relation fusion unit, used for obtaining a linking concept B through fusion of a common relation and a semantic relation;

a linking concept retrieving unit, used for retrieving the linking concept B to find out a linking literature set b;

a B topic compactness associated term identifying unit, used for identifying a second term set TC-Terms associated with topic compactness of the linking concept B, and forming a matrix of a target concept set C_{TC};

a B semantically associated term identifying unit, used for identifying a second term set MSR-Terms associated with semantics of the linking concept B, and forming a matrix of a target concept set C_{MSR};

a target concept retrieving unit, used for obtaining a target concept C through the fusion of the common relation and the semantic relation; and

a co-occurrence detecting unit, used for performing co-occurrence detection on the starting concept A and the target concept C; if the starting concept A and the target concept C do not co-occur in the same literature, storing them in a latent-association knowledge base; and if the starting concept A and the target concept C co-occur in the same literature, not storing that the starting concept A and the target concept C are associated.

In the embodiment, the fusion of a common relation and a semantic relation is performed based on the Stouffer's Z-score fusion algorithm in the linking concept retrieving unit and the target concept retrieving unit.

In conclusion, the present disclosure solves a problem how to find out valuable and reliable latent knowledge association from a large amount of scientific literatures so as to provide a new method to help scientific researchers to cross scientific islands and to facilitate interdisciplinary researches. The present disclosure discloses significant latent knowledge association, which cannot be effectively identified by the current LBD method and is latent in a large amount of scientific literatures, through the provided improved fusion method of the common relation and the semantic relation.

In each method embodiment of the present disclosure, the sequence number of each step cannot be intended to limit the sequence of the steps. Changes in the sequence of the steps also fall within the protection scope of the present disclosure without creative efforts for those ordinary skilled in the art.

It should be noted that, in the foregoing intelligent system embodiments, the module and unit division is merely logical function division, but the present disclosure is not limited to the foregoing division, as long as corresponding functions can be implemented. In addition, specific names of the functional modules and units are merely provided for the purpose of distinguishing the modules and units from one another, but are not intended to limit the protection scope of the present disclosure.

The above-mentioned embodiments are preferred embodiments of the present disclosure, but the implementation manner of the present disclosure is not limited to the embodiments. Any other changes, modifications, substitutions, combinations and simplifications without departing from the spirit essence and the principle of the present disclosure should be included within the protection scope of the present disclosure.

1: A multi-relation fusion method for latent-association literature-based discovery (LBD), comprising the following steps:
providing a starting concept A, and finding out an initial literature set a in a retrieving manner;
identifying a first term set TC-Terms associated with topic compactness of the starting concept A, and forming a matrix of a linking concept set B_{TC};
identifying a first term set MSR-Terms associated with semantics of the starting concept A, and forming a matrix of a linking concept set B_{MSR};
obtaining a linking concept B through fusion of a co-occurrence relation and a semantic relation;
retrieving the linking concept B to find out a linking literature set b;
identifying a second term set TC-Terms associated with topic compactness of the linking concept B, and forming a matrix of a target concept set C_{TC};
identifying a second term set MSR-Terms associated with semantics of the linking concept B, and forming a matrix of a target concept set C_{MSR};
obtaining a target concept C through the fusion of the co-occurrence relation and the semantic relation; and
performing co-occurrence detection on the starting concept A and the target concept C; if the starting concept A and the target concept C do not co-occur in the same literature, storing them in a latent-association knowledge base; and if the starting concept A and the target concept C co-occur in the same literature, not storing that the starting concept A and the target concept C are associated.

2: The multi-relation fusion method for latent-association LBD according to claim 1, wherein the fusion of a co-occurrence relation and a semantic relation is performed based on a Stouffer's Z-score fusion algorithm.

3: A multi-relation fusion intelligent system for latent-association LBD, which comprises:
a starting concept retrieving unit, used for providing a starting concept A, and finding out an initial literature set a in a retrieving manner;
an A topic compactness associated term identifying unit, used for identifying a first term set TC-Terms associated with topic compactness of the starting concept A, and forming a matrix of a linking concept set B_{TC};
an A semantically associated term identifying unit, used for identifying a first term set MSR-Terms associated with semantics of the starting concept A, and forming a matrix of a linking concept set B_{MSR};
a linking concept relation fusion unit, used for obtaining a linking concept B through fusion of a co-occurrence relation and a semantic relation;
a linking concept retrieving unit, used for retrieving the linking concept B to find out a linking literature set b;
a B topic compactness associated term identifying unit, used for identifying a second term set TC-Terms associated with topic compactness of the linking concept B, and forming a matrix of a target concept set C_{TC};
a B semantically associated term identifying unit, used for identifying a second term set MSR-Terms associated with semantics of the linking concept B, and forming a matrix of a target concept set C_{MSR};
a target concept retrieving unit, used for obtaining a target concept C through the fusion of the co-occurrence relation and the semantic relation; and
a co-occurrence detecting unit, used for performing co-occurrence detection on the starting concept A and the target concept C; if the starting concept A and the target concept C do not co-occur in the same literature, storing them in a latent-association knowledge base; and if the starting concept A and the target concept C co-occur in the same literature, not storing that the starting concept A and the target concept C are associated.

4: The multi-relation fusion intelligent system for latent-association LBD according to claim 3, wherein the fusion of a co-occurrence relation and a semantic relation is performed based on the Stouffer's Z-score fusion algorithm in the linking concept retrieving unit and the target concept retrieving unit.
